(19) United States
(12) Patent Application Publication
(10) Pub. No.: US 2007/0106644 A1
(43) Pub. Date: May 10, 2007

(54) Methods and apparatus for extracting and correlating text information derived from comment and product databases for use in identifying product improvements based on comment and product database commonalities

(75) Inventor: Kevin G. Minerley, Red Hook, NY (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/270,412

(22) Filed: Nov. 8, 2005

(51) Int. Cl. G06F 17/30

(52) U.S. Cl. 707/3

(57) ABSTRACT

The present invention concerns methods and apparatus for analyzing product descriptions and comment databases, and for correlating product descriptions with comment databases. In methods and apparatus of the present invention general categories of product descriptions or user comments are identified. In instances where product descriptions or user comments are subject to highly differentiable grammatical expression, several or more possible grammatical expressions are identified, or formulated. Grammatical information derived from an expression, or multiple expressions, of a comment are then used to search a comment database or product description to locate similar comments reflected in the comment database, or concerns reflected in the product description. Once similar comments or concerns are identified, the methods and apparatus of the present invention can perform various correlations. For example, correlations can be made between user comments and concerns reflected in product descriptions, or between user comments and managerial or developer expectations.

### TECHNICAL FIELD

The present invention generally concerns analysis and correlation of product descriptions and comment databases, and more generally concerns identification of similar comments in comment databases; correlation of user comments with products including but not limited to their descriptions and interfaces including but not limited to messages, screens, prompts, and various forms of help; as well as correlation of user comments with managerial and developer expectations.

### BACKGROUND

Maintenance and repair of many complex systems are managed, at least in part, using a complaint database. Users of complex systems such as, for example, graphical user interfaces; operating systems; computer systems; on-line help references; etc., often report faults using an on-line reporting system like e-mail. A collection of e-mails reporting complaints would then function as a complaint database. Although such a system is an improvement over prior methods like telephone reporting, it still has many drawbacks.

In particular, at some point a manager or technician responsible for the complex system has to read the reports (for example, e-mails) recording fault conditions that need repair. In instances where the manager or technician is responsible for a system of similar computer systems (for example, computer workstations), the manager or technician would like to be able to identify all systems that share the same fault condition so that a fix may be applied to them at the same time. In a text-based reporting system, though, this would require that the technician or manager wade through a series of e-mails, many of which will be reporting a different fault condition. Accordingly, it may be prohibitive from a time perspective to identify all systems experiencing the same fault condition by attempting to read all e-mails.

The problems are more widespread then those encountered with respect to complaint databases. Often, such facilities are better thought of as comment databases, where users share their experiences in interacting with a complex system. Over time, users may identify features of the complex system they like, and other features which, while functional, could be improved. In current comment systems, developers responsible for improving the complex system would have to wade through a series of e-mails or other electronic text information provided by users to identify likes and dislikes. Commonly, developer may select a few e-mails that are viewed as “typical”, and change the system in response to them. Such an approach often misses nuances that would become apparent through side-by-side comparison of comments from different users.

In other situations, managers and developers of complex systems may not wish to start with the comment database when initiating an analysis. Instead, managers and developers of complex systems may already have text descriptions that describe a complex system in detail such as, for example user manuals, product descriptions, a catalog of desired features, etc. Managers or developers may desire to analyze comments received from users within the context of categories established by text documents the managers or developers created themselves. For example, if a developer of a graphical user interface designed the graphical user interface to be easy-to-use from several pre-determined perspectives, the developer may wish to see how users' experiences matched up with the developer's expectations. Again, a developer may be confronted with having to read many e-mails in order to determine whether the developer's expectations were met.

Accordingly, those skilled in the art desire methods and apparatus capable of automatically analyzing complaint and comment databases. In particular, those skilled in the art desire methods and apparatus capable of identifying similar complaints or comments. Those skilled in the art also desire methods and apparatus capable of automatically cataloging complaints or comments by subject. Further, those skilled in the art desire methods and apparatus capable of correlating complaints and comments with pre-existing analytical categories.

### SUMMARY OF THE PREFERRED EMBODIMENTS

The foregoing and other problems are overcome, and other advantages are realized, in accordance with the following embodiments of the present invention.

A first embodiment of the present invention comprises a signal-bearing medium tangibly embodying a program of machine-readable instructions executable by a digital processing apparatus of a computer system to perform operations for analyzing text information associated with a first entity with which others interact. The text information, which is descriptive of the first entity, is stored in an electronic memory. The operations performed when the machine-readable instructions are executed by the digital processing apparatus comprise: identifying at least one topic reflected in the text information; selecting at least one text formulation of the at least one topic to be used in searching the text information stored in the electronic memory; generating a search argument using the text formulation of the at least one topic; and searching the text information stored in the electronic memory using the search argument to identify text relating to the topic.

A second embodiment of the present invention comprises a signal-bearing medium tangibly embodying a program of machine-readable instructions executable by a digital processing apparatus of a computer system to perform operations for correlating text information associated with a first entity with which others interact, with text information associated with a second entity. The text information associated with the first and second entities is stored in an electronic database. The operations performed when the machine-readable instructions are executed by the digital processing apparatus comprise: selecting text information associated with one of the first and second entities as source text information, wherein the text information associated with one of the first and second entities not selected operates as target text information; identifying at least one topic reflected in the source text information; selecting at least one text formulation of the at least one topic to be used in searching the text information stored in the electronic memory; generating a search argument using the text formulation of the at least one topic; searching the target text information stored in the electronic memory using the search argument to identify text relating to the topic; and correlating text found in the target text information using the search argument with the at least one topic identified in the source text information.

In conclusion, the foregoing summary of the embodiments of the invention is exemplary and non-limiting. For example, one of ordinary skill in the art will understand that one or more aspects or steps from one alternate embodiment can be combined with one or more aspects or steps from another alternate embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a block diagram of a system operating in accordance with the present invention;

FIG. 2 is a flow chart depicting a method operating in accordance with the present invention; and

FIG. 3 is a flow chart depicting another method operating in accordance with the present invention.

### DETAILED DESCRIPTION OF THE PREFERRED EMBODIMENTS

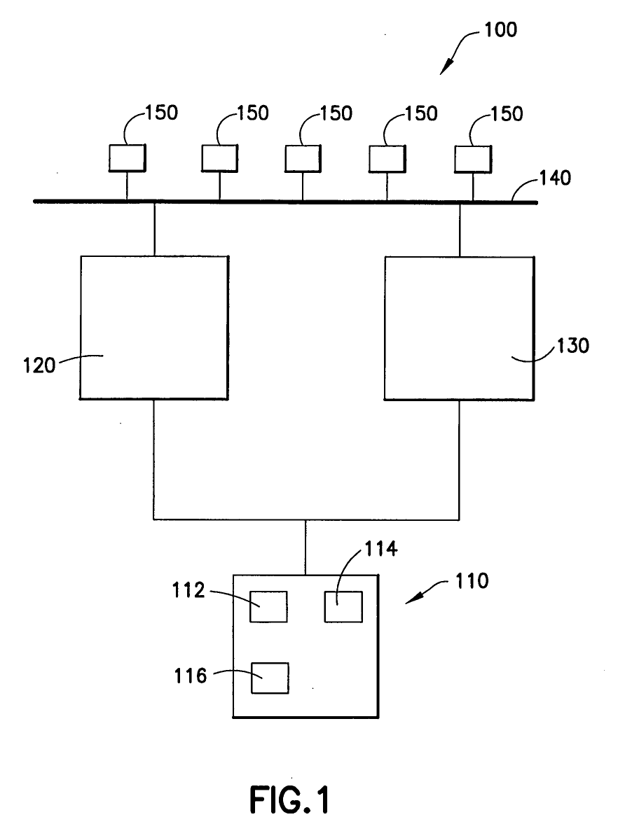

A system 100 in which the methods of the present invention may be practiced, and which reflects aspects of a system operating in accordance with the present invention, is depicted in FIG. 1. The system 100 comprises a computer system 110 for performing analytical operations in accordance with the present invention. The computer system 110 comprises digital processing apparatus 112, a memory 114 and input/output devices 116 for receiving inputs from users of the system and for displaying information to users through graphical user interfaces displayed on a display device associated with the computer system. The memory 114 is operable to store computer programs capable of performing operations in accordance with the present invention. The digital processing apparatus 112 of the present invention is operable to execute the computer program stored in memory 1114.

The computer system 110 is coupled through network interfaces to an online-help reference 120 and a comment database 130. The online-help reference 120 and comment database in turn are coupled to the internet 140 so that users can access the on-line help reference 120 using their computers 150. In various embodiments, the on-line help reference 120 may concern an entity such as an operating system, computer, computer-aided machine tool, etc. The comment database 130 is available for users to report the quality of their interaction with the entity associated with the on-line help reference. The methods of the present invention operate on comments received in the comment database 130 and analyze them in various ways. For example, if the comment database is used to report fault conditions, the methods of the present invention can be used to identify comments reporting similar fault conditions. Alternatively, the comment database may be used to report the quality of users' interactions with the entity associated with the on-line help reference 120, both good and bad. The methods and apparatus of the present invention analyze the comments and catalog them so that a manager or developer responsible for the entity can develop a complete picture of how users are finding their interactions with the entity.

In other embodiments of the present invention, the on-line help reference itself may be the subject of the comment database 130. In such situations, users may find aspects of the on-line help references difficult to understand. Users will report to the comment database 130 the quality of their interaction with the on-line help reference 120, including comments concerning aspects of the on-line help reference that are difficult to understand. The manager of the on-line help reference 130 can use the methods and apparatus of the present invention to catalog comments that are being received. For example, instead of responding to a comment that is thought to be typical, a manager would use the methods and apparatus of the present invention to locate all comments relating to a particular problem users are having with the on-line help reference. By having a range of comments available, a manager is in a position to respond to nuances only apparent in side-by-side comparisons of the comments.

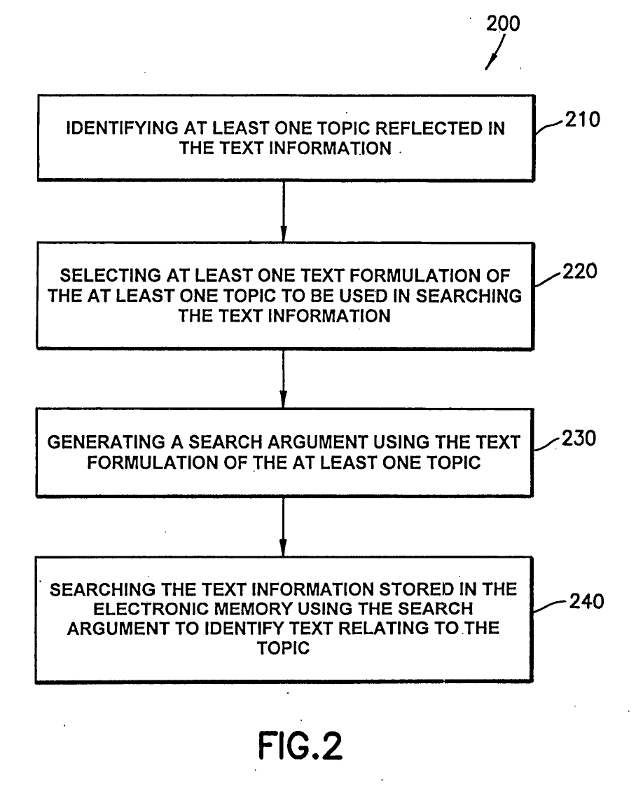

A method capable of operating in accordance with the present invention is depicted in FIG. 2. The method 200 depicted in FIG. 2 is generally operable in a system like that depicted in FIG. 1, where comments and/or complaints are registered electronically over the Internet or a corporate Intranet. In general, the comment or complaint database will be a collection of electronic documents (for example, e-mails) describing a user's experience with an entity with which the user is interacting. The entity can be many things in the context of the invention such as, for example, a computer system; an operating system; a productivity suite; a machine; an on-line user manual; or an on-line help reference.

In the method of the invention, at step 210, at least one topic reflected in the text information comprising a comment database stored in an electronic memory is identified.

Next, at step 220, at least one text formulation of the at least one topic to be used in searching the text information is selected. Then, at step 230, a search argument using the text formulation of the at least one topic is generated. Next, at step 240, the text information stored in the electronic memory, and which comprises the comment database, is searched using the search argument to identify text relating to the topic reflected in the search argument.

In various embodiments of the present invention, the topic to be used in searching the comment database can be identified in many ways. In one embodiment, the topic may be identified in response to user input. For example, a computer technician interested in searching the comment database for reports of a particular fault condition may specify a topic corresponding to that fault condition. In other embodiments, analysis of the comment database itself would provide the topics. In such an embodiment, the text information stored in the electronic memory would be analyzed for text segments (words, phrases or sentences) that occur a plurality of times in the text information. The embodiment would then calculate the frequency of appearance. The topic then would be automatically selected based on a predetermined frequency of appearance criterion (most frequent; five most frequent; ten most frequent; or least frequent). Alternatively, the topic would be selected by user input. For example, the identified text segments, along with their frequency of appearance, would be presented to a user; and the system would then receive the user's selection of a topic selected from the identified text segments.

Intentionality and variability may also be used to select topics for use in analyzing text information. “Intentionality” refers to intentions of an author of a document evident in the document itself. For example, placing information in a heading, as opposed to the body of a document, often reflects an author's intention to emphasize the information. Information that appears in main headings may then be more important than information appearing in sub-headings. Information in the body of a document which is set apart in some way—for example, by using hyphens—may be more important than text not set apart in any way. Accordingly, any organizational schema or emphasis evident in text information may be used to rank topics in order of importance.

“Variability” refers to situations where a person identifies a predicate topic in text information, and wants to collect comments concerning not only the predicate topic, but also comments concerning topics related to the predicate topic. Variability may be reflected in many ways. For example, topics concerning additional praiseworthy aspects of an on-line help reference may be captured when a search criterion reflecting variability is applied to find topics related to an initial praiseworthy aspect. A search criterion reflecting variability may capture both negative and positive aspects of an on-line help reference.

In embodiments of the invention, the text formulation of the topic, which is used as input for generating a search argument, is selected in various ways. For example, the text formulation may correspond to a phrase selected by a user, or to a phrase that most frequently appears in the text information. Alternatively, if the topic selected is subject to highly differentiable grammatical expression, multiple text formulations of the topic would be generated and used for creating comprehensive search arguments likely to find most comments relating to the topic, however the comments are expressed. A topic may be expressed differently by making changes to: syntax, semantics, morphology, parts-of-speech, rhetorical devices or tropes, and more conventionally phrases, sentences, and paragraphs.

In situations where the topic is subject to highly differentiable expression, the multiple resulting search arguments will be used to search the text information. The text identified in response to the multiple search arguments will be then be correlated with the topic.

In other embodiments of the method depicted in FIG. 2, additional steps may be performed. For example, remedial action may be taken. If the entity is a graphical user interface, and some aspect of its operation is confusing, the graphical user interface can be re-programmed to operate in a less-confusing manner. If the entity is a computer system comprised of multiple work stations, and the search revealed that a number of work stations are experiencing a fault condition, then a repair would be spawned to those faulty work stations. If the entity is an electronic document or on-line help reference some aspect of which is difficult to understand or confusing, the remedial action would comprise a re-drafting of a text segment or explanation so that it is less confusing.

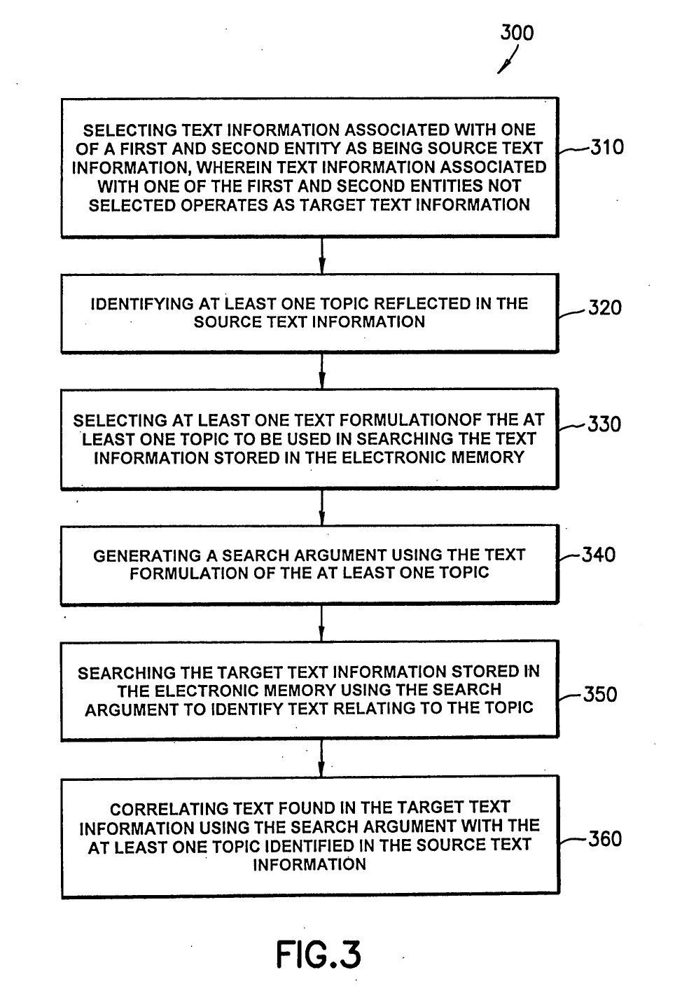

Another method 300 operating in accordance with the present invention is depicted in FIG. 3. In the method depicted in FIG. 3, categories selected from text information (“source text information”) associated with a first entity are used to analyze text information (“target text information”) associated with a second entity. In a typical example, the first entity is a user's manual explaining how to operate a second entity, like an operating system, computer work station, computer-controlled machining equipment etc. The source text information associated with the first entity would be the user manual itself. The target text information would be a comment or complaint database containing text information (e-mails) which relates users' experiences with the second entity. Alternatively, the source text information may be topics which are of interest to a manager or developer of the second entity, and which seek both positive and negative feedback from users.

In the method 300, the first step 310 selects which text information is to operate as the source text information. The text information associated with one of the first and second entities not selected as the source text information will operate as the target text information. Topics identified in the source text information will be used to search the target text information. It should be noted that in the examples previously described, a user's manual can operate as the source text information and the comment database as the target text information, or vice-versa. In the next step 320, at least one topic is identified in the source text information. Then, at step 330, at least one text formulation of the at least one topic is selected to be used in searching the target text information stored in an electronic memory. Next, at step 340, a search argument is generated using the text formulation of the at least one topic. Then, at step 350, the target text information stored in the electronic memory is searched using the search argument to identify text relating to the topic. Next, at step 360, the text found in the target text responsive to the search argument is correlated with the at least one topic identified in the source text information.

Various alternate embodiments of the method depicted in FIG. 3 are contemplated. For example, in one alternate embodiment, a user would be interested in identifying text relating to a plurality of topics identified in, for example, a catalog of desired features. The catalog of desired features for an entity would operate as the source text information. A comment database of user experiences with the entity would operate as the target text information. In this alternate embodiment, a plurality of topics reflected in the source text information would be identified; at least one text formulation would be selected for each of the topics; a search argument would be generated for each of the topics using the text formulation of the topic; a search would be performed using each of the search arguments; and the text identified using each of the search arguments would be correlated with the corresponding topic.

A particular advantage of the present invention is apparent in this variant. A developer need not read through a mountain of e-mails in order to catalog the complete range of user reactions to a product in development. Instead, the developer would employ pre-determined categories selected by the user herself in order to catalog user reactions to the product in development. Another advantage of the present invention is the developer need not create a topic list from scratch. Instead, the developer can use a pre-existing text document in electronic form (e.g., a user's manual) to analyze user reactions.

Further variants of the method depicted in FIG. 3 are contemplated. For example, in one variant, identifying at least one topic reflected in the source text information would comprise analyzing the source text information stored in the electronic memory for text segments that occur a plurality of times; and calculating the frequency of appearance of each text segment. In this variant, identifying at least one topic would then be done by selecting at least one text segment on a basis of a predetermined frequency of appearance criterion and using the text segment as the topic. In another variant identifying at least one topic would be done by first presenting the identified text segments, along with their frequency of appearance, to a user of the method; and then by receiving a selection of a particular text segment from the user, wherein the selected text segment will be used as the at least one topic.

Still further variants of the method depicted in FIG. 3 are contemplated. If it is determined that a topic is subject to highly differentiable grammatical expression, then multiple text formulations of the topic would be generated, and the multiple text formulations would be used to search the target text information stored in the electronic memory. One way in which the target text information could be searched using the multiple text formulations of the at least one topic would be by generating search arguments using each of the multiple text formulations.

One skilled in the art will understand that the methods depicted in FIGS. 2 and 3 can be embodied in a physical memory medium readable by digital processing apparatus associated with a computer system in other embodiments made in accordance with the invention. In these embodiments of the invention, computer program instructions of a computer program fixed in the physical memory medium are capable of performing operations corresponding to the steps of the method when executed by a digital processing apparatus. Physical machine-readable memory media include, but are not limited to, hard drives, CD- or DVD-ROM, flash memory storage devices, or RAM memory of a computer system.

Thus it is seen that the foregoing description has provided by way of exemplary and non-limiting examples a full and informative description of the best methods and apparatus presently contemplated by the inventor for extracting text information from product descriptions and comment databases for use in analyzing product descriptions and comment databases, and for correlating user comments with product descriptions and managerial and developer expectations. One skilled in the art will appreciate that the various embodiments described herein can be practiced individually; in combination with one or more other embodiments described herein; or in combination with comment and complaint systems differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

What is claimed is:

1. A signal-bearing medium tangibly embodying a program of machine-readable instructions executable by a digital processing apparatus of a computer system to perform operations for analyzing text information associated with a first entity with which others interact, the text information stored in an electronic memory and descriptive of the first entity, the operations comprising:
identifying at least one topic reflected in the text information;
selecting at least one text formulation of the at least one topic to be used in searching the text information stored in the electronic memory;
generating a search argument using the text formulation of the at least one topic; and
searching the text information stored in the electronic memory using the search argument to identify text relating to the topic.

2. The signal-bearing medium of claim 1 wherein identifying at least one topic reflected in the text information further comprises:
analyzing the text information stored in the electronic memory for text segments that occur a plurality of times in the text information; and
calculating the frequency of appearance for each distinct text segment.

3. The signal-bearing medium of claim 2 wherein identifying at least one topic reflected in the text information further comprises:
selecting at least one text segment on the basis of a predetermined frequency of appearance criterion and using the text segment as the at least one topic.

4. The signal-bearing medium of claim 2 wherein identifying at least one topic reflected in the text information further comprises:
presenting the identified text segments, along with their frequency of appearance, to a user; and
receiving selection of a particular text segment from the user, the selected text segment to be used as the at least one topic.

5. The signal-bearing medium of claim 1 wherein identifying at least one topic is performed in dependence on intentionality concerning the at least one topic reflected in the text information.

6. The signal-bearing medium of claim 1 wherein intentionality concerning the at least one topic is reflected by at least one criterion selected from the group comprising: mention of the at least one topic in a table of contents; mention of the at least one topic in a heading; mention of the at least one topic in a main heading; mention of the at least one topic in a sub-heading; position of first mention of the at least one topic within the text information; grammatical emphasis of the at least one topic; detection of associated text identifying the at least one topic as important; and detection of associated text identifying the at least one topic as unimportant.

7. The signal-bearing medium of claim 1 wherein identifying at least one topic reflected in the text information further comprises:
identifying a first topic from analysis of the text information; and
creating at least a second topic from the first topic based on variability associated with the first topic.

8. The signal-bearing medium of claim 7 wherein the at least a second topic is created by using at least one method selected from the group of: creating at least a second topic by creating a topic that is subject-matter-related to the first topic; creating at least a second topic by negativing the subject matter of the first topic; creating at least a second topic that shares a similar user response as the first topic; and creating at least a second topic that shares an opposite user response as the first topic.

9. The signal-bearing medium of claim 7 wherein selecting at least one text formulation further comprises selecting at least one text formulation for each of the first and second topics; wherein generating a search argument further comprises generating search arguments using the text formulations selected for each of the first and second topics; and wherein searching the text information further comprises searching the text information stored in the electronic memory using the search arguments generated for each of the first and second topics.

10. The signal-bearing medium of claim 1 wherein selecting at least one text formulation of the at least one topic further comprises:
determining if the at least one topic is subject to highly differentiable grammatical expression; and
if the at least one topic is subject to highly differentiable grammatical expression, generating multiple text formulations of the at least one topic, and using the multiple text formulations of the at least one topic to search the text information stored in the electronic memory.

11. The signal-bearing medium of claim 10 wherein generating a search argument further comprises:
generating search arguments using the multiple text formulations of the at least one topic.

12. The signal-bearing medium of claim 11 wherein searching the text information stored in the electronic memory further comprises:
searching the text information stored in the electronic database using the search arguments generated from the multiple text formulations of the at least one topic.

13. The signal-bearing medium of claim 1 wherein the text information comprises comments received from users of the first entity.

14. The signal-bearing medium of claim 13 wherein the text information further comprises complaints received from users of the first entity, whereby the at least one topic concerns a particular category of complaint, and wherein searching the text information stored in the electronic memory using the search arguments locates complaints falling within the particular category of complaint corresponding to the at least one topic.

15. The signal-bearing medium of claim 14 wherein the first entity comprises a plurality of similar computer systems and the others comprise users of the computer systems, the operations further comprising:
repairing the computer system of each user reporting a complaint falling within the particular category of complaint corresponding to the at least one topic.

16. A signal-bearing medium tangibly embodying a program of machine-readable instructions executable by a digital processing apparatus of a computer system to perform operations for correlating text information associated with a first entity with which others interact, with text information associated with a second entity, the text information associated with the first and second entities stored in an electronic database, the operations comprising:
selecting text information associated with one of the first and second entities as source text information, wherein the text information associated with one of the first and second entities not selected operates as target text information;
identifying at least one topic reflected in the source text information;
selecting at least one text formulation of the at least one topic to be used in searching the text information stored in the electronic memory;
generating a search argument using the text formulation of the at least one topic;
searching the target text information stored in the electronic memory using the search argument to identify text relating to the topic; and
correlating text found in the target text information using the search argument with the at least one topic identified in the source text information.

17. The signal-bearing medium of claim 16 wherein a plurality of topics reflected in the source text information are identified; wherein at least one text formulation for each of the plurality of topics is selected; wherein a search argument is generated for each of the text formulations; wherein the target text information is searched using each of the search arguments to identify text relating to the topic corresponding to the search arguments; and wherein text found in the target text information in response to use of a particular search argument is correlated with the topic corresponding to the particular search argument.

18. The signal-bearing medium of claim 16 wherein identifying at least one topic reflected in the source text information further comprises:
analyzing the source text information stored in the electronic memory for text segments that occur a plurality of times; and
calculating the frequency of appearance for each distinct text segment.

19. The signal-bearing medium of claim 18 wherein identifying at least one topic reflected in the source text information further comprises:
selecting at least one text segment on a basis of a predetermined frequency of appearance criterion and using the text segment as the at least one topic.

20. The signal-bearing medium of claim 18 wherein identifying at least one topic reflected in the text information further comprises:
presenting the identified text segments, along with their frequency of appearance, to a user; and
receiving a selection of a particular text segment from the user, the selected text segment to be used as the at least one topic.

21. The signal-bearing medium of claim 16 wherein selecting at least one text formulation of the at least one topic further comprises:
determining if the at least one topic is subject to highly differentiable grammatical expression; and
if the at least one topic is subject to highly differentiable grammatical expression, generating multiple text formulations of the at least one topic, and using the multiple text formulations to search the target text information stored in the electronic memory.

22. The signal-bearing medium of claim 21 wherein generating a search argument further comprises:
generating search arguments using the multiple text formulations of the at least one topic.
